(19) United States
(12) Patent Application Publication
(10) Pub. No.: US 2008/0291444 A1
(43) Pub. Date: Nov. 27, 2008

(54) Method of Spectroscopy

(75) Inventors: Paul Donaldson, London (GB); David Klug, London (GB)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: IMPERIAL INNOVATIONS LIMITED, LONDON, EN (GB)

(21) Appl. No.: 11/914,960

(22) PCT Filed: May 19, 2006
(86) PCT No.: PCT/GB2006/001870

§ 371 Date: Aug. 1, 2008

(30) Foreign Application Priority Data
May 20, 2005 (GB) 0510354.4

(51) Int. Cl. G01N 21/63

(52) U.S. Cl. 356/317

(57) ABSTRACT

A method of multidimensional spectroscopy has a controllable excitation source parameter and comprises controlling said controllable parameter to excite a vibrational mode of the sample, generating a homodyne reflected signal from the sample and obtaining a spectrum of the sample from the reflected signal.

The invention relates to a method of spectroscopy, in particular multidimensional spectroscopy.

A range of spectroscopic approaches are known for investigating the coupling of two or more level systems. One known approach is two-dimensional nuclear magnetic spectroscopy (2D-NMR). An example of such a system is described in Friebolin, “Basic one- and two-dimensional NMR spectroscopy” 2^{nd} edition (April 1993) John Wiley & Sons. NMR relies on the interaction of magnetic nuclei with an external magnetic field, as is well known. In order to spread out crowded data in an NMR spectrum, 2D NMR has been developed. In a typical 2D-NMR scheme the sample is subjected to first and second excitation pulses separated by a delay interval. Because of interactions within the sample and in particular spin-spin coupling, information obtained from the second excitation pulse differs from the information obtained from the first excitation pulse providing an extra dimension. A Fourier transformation is applied to the time spectrum from each excitation pulse to obtain a respective frequency spectrum. The frequency spectra are plotted on orthogonal axes to form a surface. Peaks on the surface provide additional information concerning interactions within the sample.

2D-NMR plots can be used to determine molecular structure and provide unique, characteristic features (“fingerprints”) for identifying components in a solution. There are a great many applications for the analysis of complex mixtures of molecules in chemistry, biology, and other disciplines. However 2D-NMR suffers from a lack of sensitivity, with detection limits typically on the order 10¹⁵-10¹⁸ molecules. In addition 2D-NMR provides only limited resolution in the time domain.

In another known method of spectroscopy, techniques analogous to those used in 2D-NMR spectroscopy have been adopted in 2D vibration or infrared (IR) spectroscopy, where vibrational modes of an atom or molecule are excited. One such known technique is the so-called “pump-probe” technique as described in Woutersen et al “Structure Determination of Trialanine in Water Using Polarization Sensitive Two-Dimensional Vibrational Spectroscopy” J. Phys. Chem. B 104, 11316-11320, 2000. Further 2D-IR pump-probe experiments have been performed, for example as described in Hamm et al “The two-dimensional IR non-linear spectroscopy of a cyclic penta-peptide in relation to its three-dimensional structure” Proc. Nat. Acad. Sci. 96, 2036, 1999.

According to known 2D IR systems a first, pump pulse is followed by a probe pulse and the resulting frequency spectra plotted on respective axes to provide a surface representing information about vibration-vibration interactions in the sample. Because the mathematical description of coupled two-level quantum systems is essentially identical, the analytical principles and techniques used in 2D-NMR are equally applicable in 2D IR spectroscopy. However detectivity is severely limited by input laser noise and the results show extremely small changes on a large background signal arising from transmission of an additional unwanted non-resonant background signal from the sample.

No existing technique provides a high quality output signal without the production of unwanted background signals, combined with high temporal resolution down to the timescale of molecular interactions allowing a full frequency and time-result fingerprint of a given complex chemical sample.

In addition to the spectroscopic techniques already discussed, there are a number of known techniques such as Laser induced fluorescence (LIF), dispersed fluorescence excitation (DFE), resonance enhanced multiphoton ionisation (REMPI), and photoelectron spectroscopy (PES) which take advantage of the strong electronic absorption of visible laser light to probe vibrations of molecules in the gas phase. However, these techniques fail to resolve vibrations in the condensed phase and can only be applied to small molecules.

Raman spectroscopy is a further visible laser technique capable of resolving vibrations in the condensed phase. A visible beam is scattered from a sample and small changes in the wavelength of the scattered light are measured. These changes correspond directly to vibrational transitions. Raman spectroscopy is a very powerful technique for structure and composition in the condensed phase but is 1D and not very effective unless the sample is concentrated. It is not good for detecting vibrations that approach the near infrared in frequency

Resonance Raman spectroscopy improves the sensitivity problem of ‘ordinary’ Raman spectroscopy by tuning the visible beam near an electronic resonance, increasing the scattered signal. Adding an additional visible beam to stimulate the scattering gives CARS (coherent anti-stokes Raman scattering). CARS can be done at resonance or ‘pre-resonant’. Resonant CARS and Raman are 2D techniques but both suffer from non resonant background problems which limit their sensitivity, especially when resonant.

According to another aspect in known 2D spectroscopic techniques, in order to produce a useful output signal the sample used must be of a high quality. For example, it may be necessary to provide a layer of sample which is completely flat, without a meniscus, in order to produce accurate results. Preparation of such high-quality samples can be both costly and time consuming, therefore placing restrictions on the number and range of samples on which the technique can be carried out.

The invention is set out in the claims. Because the multidimensional spectroscopy is carried out in reflective mode this solves the problem of unwanted non-resonant background signals being generated. The excitation of an electronic mode of the sample in addition to the excitation of a vibrational mode provides an enhanced output signal, and can also be used to generate 3 dimensional spectrums. Depositing the sample directly onto a substrate and allowing it to dry is more time and cost effective than traditional sample deposition methods and still enables the production of high quality spectroscopic images.

Embodiments of the invention will now be described, by way of example, with reference to the Figures, of which:

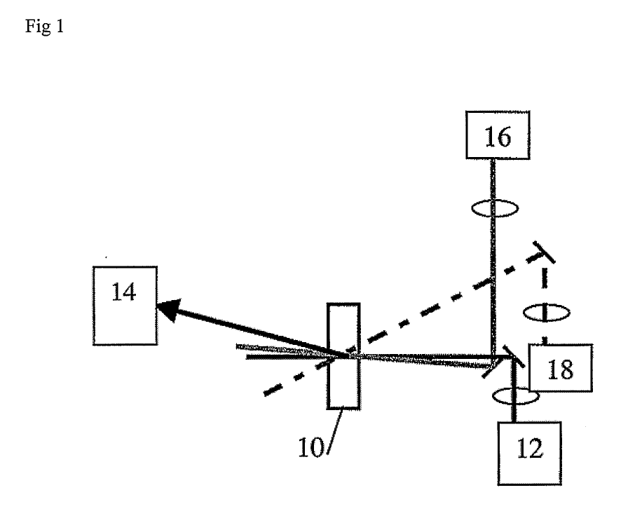

FIG. 1 shows an apparatus for performing a method of spectroscopy according to the present invention.

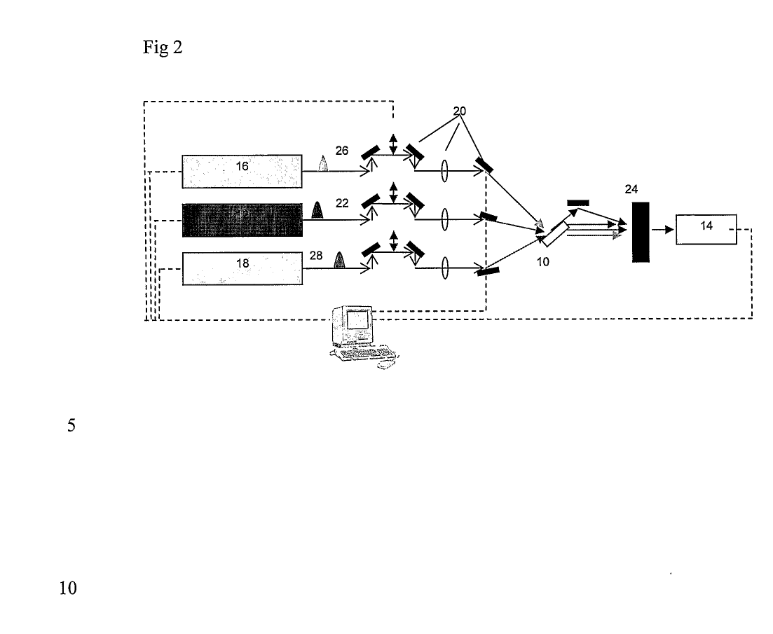

FIG. 2 shows an apparatus for performing a double vibrationally and single electronically enhanced spectroscopy experiment, according to a further embodiment of the present invention.

In overview the invention relates to a method of spectroscopy relying on excitation of a vibrational mode of atoms or molecules in a system for example by excitation by an infrared excitation source. Interactions between vibrations in the system allow two or more dimensional information to be obtained with suitable excitation regimes. The present invention relies on reflective mode spectroscopy and in particular uses multiplexed homodyne reflection spectroscopy. As a result, a strong output signal can be produced without swamping by an unwanted non-resonant background signal which is generated in the transmissive mode. In addition or alternatively the invention further relies on visible resonance enhancement and in particular on the excitation of electronic resonances within atoms or molecules in a system for example by excitation by a visible excitation source. As a result three dimensional information may be obtained with suitable excitation regimes. Yet further the invention relies on the dropwise deposition of a sample of the atoms or molecules onto a surface in preparation for spectroscopy to be performed, wherein the surface may be an adsorptive substrate. As a result sample preparation is more cost and time effective than in known multidimensional spectroscopic methods.

Referring to FIG. 1 the apparatus is shown generally as including a sample 10, excitation sources comprising lasers 12, 18 emitting radiation typically in the infrared band and a detector 14. Tuneable lasers 12 and 18 emit excitation beams of, for example, respective wavelengths/wavenumbers 3164 cm⁻¹ (ω₁) and 2253 cm⁻¹ (ω₂) which excite one or more vibrational modes of the molecular structure of the sample 10 and allow multi-dimensional data to be obtained by tuning the frequencies or providing variable time delays. A third beam is generated by a third laser 16 to provide an output or read out in the form of an effectively scattered input beam, frequency shifted (and strictly generated as a fourth beam) by interaction with the structure of sample 10. The frequency (ω₃) of the third beam preferably lies in the visible range and may be variable or fixed, for example at 795 nm, as is discussed in more detail below. The detected signal is typically in the visible or near infrared part of the electromagnetic spectrum eg at 740 nm, comprising photons of energy not less than 1 eV.

Although the invention is referred to herein as using tuneable lasers 12 and 18 to excite one or more vibrational modes of the sample 10, it will be appreciated by the skilled person that this terminology also encompasses inducing vibrational coherences within the sample 10.

In order to obtain multi-dimensional data, the sample is excited by successive beams spaced in the time domain. This approach uses a frequency domain technique with time spaced pulses, however it will be appreciated that any appropriate multi-dimensional spectroscopic technique can be adopted, for example by using a full time domain experiment or by using other non-linear excitation schemes. Similarly any number of dimensions can be obtained by additional pulses in the time domain or additional frequencies in the frequency domain.

In order to produce a strong output signal without the generation additional unwanted signals, a reflection scheme is used. In traditional 2D spectroscopy methods, reflection schemes are not implemented because the reflected signal is too weak to be detected accurately. A transmission scheme is therefore used, wherein the output signal travels through the sample and then though the material on which the sample is deposited, for example glass. This results in the generation of an additional non-resonant background signal being transmitted through the glass along with the desired resonant output signal.

In a preferred embodiment of the invention, the reflected signal is produced by four-wave mixing (FWM). Four wave mixing occurs in a polarisable medium when three time varying fields of sufficient strength induce a nonlinear polarisation that oscillates at a frequency ω₄.

ω₄=ω₁±ω₂±ω₃ 1)

As explained in more detail below, ω₁ and ω₂ are preferably in the infra-red range, with each laser 12, 18 being tuned to a separate vibrational resonance of the sample 10. The third laser 16 produces a beam of frequency ω₃ which preferably lies in the in the visible range. If ω₃ lies in the visible range, ω₄ produced can also lie in the visible range, making it detectable by a simple method of photon counting.

The polarisation described above launches a field that also oscillates at ω₄. In practice the fields used to create ω₄ are sub-nanosecond laser pulses. The different signs in equation 1) yield various ω₄ frequencies and can be selected by introducing angles between the laser pulses (phase matching) or spectral dispersion of the output signals.

Four wave mixing becomes a spectroscopy when one or more of the laser fields are tuned in frequency ωₗₐₛₑᵣ through an electronic or vibrational resonance feature of the sample 10 probed. The polarisation becomes very large around a resonance and the four wave mixing signal increases as:

$${E}_{4} ∝ {\sum }_{resonances , lasers} \frac{A}{{ϖ}_{res} - {ϖ}_{laser} - i Γ} \qquad 2 )$$

A is a constant, ωᵣₑₛ is the frequency of the resonance and Γ is the lifetime of the induced polarisation.

In a preferred embodiment, the invention uses Doubly Vibrationally Enhanced four wave mixing (DOVE-FWM), as described by Wei Zhao and John C Wright in “Phys. Rev. Lett, 2000, 84(7), 1411-1414”. DOVE-FWM occurs when ω₁ and ω₂ are resonant with coupled vibrations within the sample, v₁, v₂ and v₃. In this case the signal increases as:

$${E}_{4} ∝ \frac{{A}_{DOVE \text{-} IR}}{\begin{matrix}( {ϖ}_{{v}_{1}} - {ϖ}_{1} - i {Γ}_{{v}_{1} g} ) \\ ( {ϖ}_{{v}_{2}} - {ϖ}_{2} - {Γ}_{{v}_{2} g} )\end{matrix}} + \frac{{A}_{DOVE \text{-} RAMAN}}{\begin{matrix}( {ϖ}_{{v}_{1}} - {ϖ}_{1} - i {Γ}_{{v}_{1} g} ) \\ ( {ϖ}_{{v}_{3}} - ( {ϖ}_{1} - {ϖ}_{2} ) - i {Γ}_{{v}_{3} g} )\end{matrix}} \qquad 3 )$$

The signals here are products of resonance terms and hence larger than the sum of resonance terms in Equation 2. Mapping the signal for all combinations of ω₁ and ω₂ gives a 2D map of coupled vibrations in the material probed.

The reflected beam produced is therefore of a different frequency, ω₄, to any of the input beams, and a strong signal is produced by DOVE-FWM, therefore it is easily detected. Furthermore, because the signal being detected travels only within the sample and not through the bulk that it is contained on, the additional non-resonant signal associated with transmission scheme spectroscopy is not produced.

In a further embodiment, “multiplexing” of the type described in Muller et al, “Imaging the Thermodynamic State of Lipid Membranes with Multiplex CARS Spectroscopy” J. Phys. Chem. B. 106, 3715-3723, which is incorporated by reference, is achieved by the use of broadband pulses in the infrared, created by ultrafast pulses to simultaneously excite infrared transitions in the sample and the spectral portions surrounding them. By appropriate selection of the input angles of the beams, unique directions corresponding to input frequencies can be achieved. As a result the output signal is a cone of rays containing all of the spectral information in space; the detector 14 can in this case be a 2D array detector such as a charge coupled device (CCD) which captures the spectral information encoded into spatial dimensions. Once again to obtain improved resolutions of spectra, in addition to the spatial dimensions, additional dimensions are introduced either by time delays in the pulses or by frequency variations as discussed in more detail above to give yet further, fully detailed information concerning the spectrum generated by the sample.

It will be appreciated by the skilled reader that while it is possible for the present invention to encompass multiplexing, it is not a necessary embodiment.

Although the invention is referred to as reflective mode spectroscopy, it will be appreciated by the skilled person that the reflection is not limited to the surface of the sample and therefore that this terminology also encompasses evanescent mode spectroscopy. The nature of the reflected signal produced will vary according to input beam penetration depth. Factors which determine the penetration depth include the angle of incidence of the third frequency input beam and the polarisation of the field.

According to one embodiment of the invention, a chopper may be used to periodically block the signal from one of the two tuneable lasers (12, 18). When only one laser (12, 18) is being used, the signal output will correspond to surface reflection only, in accordance with known second order non-linear techniques such as sum-frequency generation (SFG). The results produced when one laser (12, 18) is blocked may be subtracted from those produced when both lasers (12, 18) are active, in order to ensure that evanescent mode effects are being observed.

Whilst the present invention has been described in relation to homodyne spectroscopy it will be appreciated by the skilled reader that certain of the embodiments may also be realised for heterodyne spectroscopy. By way of definition, all spectroscopic methods including the present invention emit a signal whose intensity can be defined as follows:

I=(E_{LO})²+(E_{HO})²+(E_{LO}×E_{HO}) cos φ 4)

Here, E_{HO} is the homodyne signal from the sample and E_{LO} is a “local oscillator” field. The two fields are of the same frequency but have a fixed phase difference φ. In standard homodyne detection, there is no local oscillator field, and the intensity is simply the homodyne term E_{HO}², which varies quadratically with the concentration of the sample. In heterodyne detection, a separate local oscillator is created and manipulated by any known method as will be apparent to the skilled reader, so that the cross term can be made to dominate the equation. The output field is then linear in sample concentration. This may be used in certain embodiments in which the sample concentration is low and it is desirable to produce a stronger output signal.

It will be appreciated that the set-up of the present invention allows the user to tune the lasers (12, 18) and to change spectral regions easily. In order to produce a high quality output, the laser beams must have good spatial quality and the pulses must be synchronized. Furthermore, beam angles must be chosen so that they converge at the sample, all in a manner that will be apparent to the skilled reader and dos not require discussion here. In an advantage over traditional 2D IR methods, there is no need to phase control the laser beams.

As shown in FIG. 2, in yet a further embodiment of the invention, ω₁ and ω₂ can be selected to give DOVE-FWM and ω₃ then tuned near an electronic resonance of excitation frequency ωₑ. Tuneable IR lasers (12, 18) and tuneable visible laser (16) produce pulses (22, 28, 26) which may be delayed by a series of spatial filters and focussing lenses and mirrors (20) in order to converge the beams at the sample 10. The reflected signal is then passed through a filter or grating 24 before being passed to the detector 14.

If the electronic resonance is coupled to the vibrations that ω₁ and ω₂ probe, a further multiplicative enhancement can be made to both terms in Equation 3). The technique will give a 3D map of electronic/vibrational coupling. For example, the DOVE-IR case becomes:

$${E}_{4} ∝ \frac{{A}_{DOVESE \text{-} IR}}{\begin{matrix}( {ϖ}_{{v}_{1}} - {ϖ}_{1} - i {Γ}_{{v}_{1} g} ) ( {ϖ}_{{v}_{2} g} - {ϖ}_{2} - i {Γ}_{{v}_{2} g} ) \\ ( {ϖ}_{e} - {ω}_{3} - i {Γ}_{e} )\end{matrix}} \qquad 5 )$$

If the vibrations probed by ω₁ and ω₂ are not coupled to the electronic state, the electronic enhancement is described by Equation 2) and therefore much weaker than that of Equation 5).

Delays between the laser pulses suppress non resonant or singly resonant signals and select the various possible FWM signals of interest. This method is discussed further by John Wright in “J. Chem. Phys, 2001, 266, 177-195”. No existing technique takes advantage of the strong electronic absorption of visible laser light for use in 2 or more dimensional vibrational spectroscopy whilst providing strong output signals and minimal non resonant background noise.

Although a reflection scheme is described in relation to this embodiment, it will be apparent to the skilled person that visual resonance enhancement may also be implemented in a transmission scheme.

The present invention further provides a method of dropwise deposition of a sample onto a surface in preparation for multidimensional spectroscopy to be performed. For the purposes of the invention, the surface is preferably planar and made of glass or any other suitable material. In a particular embodiment, the surface may comprise an adsorptive substrate, such as TiO₂. The dropping onto the surface of the sample may be performed using a pipette or by any other appropriate method, as will be apparent to the skilled person. It will be appreciated that the preferred method of deposition will vary according to several factors including the viscosity of the sample 10. Once the sample 10 has been dropped onto the surface, it should be left for an appropriate length of time to allow excess sample to evaporate off. The length of time will again vary according to the nature of the sample 10 being studied. Once the sample 10 is sufficiently dry, it may be inserted into the appropriate apparatus such as that shown in FIG. 1 or FIG. 2 and spectroscopy may be carried out.

Although a reflection scheme is described herein, it will be apparent to the skilled person that this sample deposition method may also be implemented in a transmission scheme. The method may be used to produce high quality results without using costly and time-consuming sample preparation techniques. It will be appreciated that the nature of the samples used may vary widely, and may include materials such as plastics, paints, food samples, membranes, water soluble proteins and peptides.

The invention can be implemented in a range of applications and in particular any area in which multi-dimensional optical spectroscopy measuring, directly or indirectly, vibration/vibration coupling is appropriate, using two or more variable frequencies of light or time delays to investigate molecular identity and/or structure.

The skilled person will recognise that any appropriate specific component and techniques can be adopted to implement the invention. Typically at least one tuneable laser source in the infrared and at least one other tuneable laser source in the ultraviolet, visible or infrared can be adopted and any appropriate laser can be used or indeed any other appropriate excitation source. A further fixed or tuneable frequency beam may also be incorporated in the case of two infrared excitation beams as discussed above. Alternatively, a commercial sub-nanosecond laser system for FWM experiments can be used to generate separate frequencies from a single laser seed source including three independently tuneable beams.

The sample and solvent can be of any appropriate type whereby its composition is controlled to tune the system, and in any appropriate phase including gas phase and liquid/solution phase. Any appropriate detector may be adopted, for example a CCD or other detector as is known from 2D IR spectroscopy techniques.

The range of excitation wavelengths produced by lasers 12 and 18 is generally described above as being infrared but can be any appropriate wavelength required to excite a vibrational mode of the structure to be analysed. Similarly, the wavelength produced by third laser (16) is generally described as being visible but can be any appropriate wavelength required to excite an electronic resonant mode of the structure to be analysed. Although the discussion above relates principally to two or three-dimensional analysis, any number of dimensions can be introduced by appropriate variation of the parameters of the input excitation, for example frequency, time delay/number of pulses or any other appropriate parameter.

Although four-wave mixing is described, alternatively other modes such as three wave mixing may be implemented in which case the output is in the rear infrared.

1. A method of multi dimensional spectroscopy having a controllable excitation source parameter, comprising controlling said controllable parameter to excite a vibrational mode of the sample, generating a homodyne reflected signal from the sample and obtaining a spectrum of the sample from the homodyne reflected signal.

2. A method as claimed in claim 1 wherein the reflected homodyne signal is created by four wave mixing or three wave mixing.

3. A method of spectroscopy having a controllable excitation source parameter, comprising controlling said controllable parameter to excite a vibrational mode of the sample, generating an output signal and further comprising enhancing the output signal by controlling a controllable parameter to excite an electronic mode of the sample and obtaining a vibrational spectrum of the sample.

4. A method of spectroscopy as claimed in claim 3 wherein the vibrational spectrum obtained is in at least 2 spectral dimensions.

5. A method of multidimensional spectroscopy comprising depositing a sample on a substrate, allowing it to dry, controlling a controllable parameter to excite a vibrational or electronic mode of a sample and obtaining a spectrum of the sample.

6. A method of multidimensional spectroscopy as claimed in claim 5 wherein the substrate comprises an adsorptive material.

7. A method as claimed in claim 1 further comprising the step of enhancing the reflected homodyne signal by controlling a controllable parameter to excite an electronic mode of the sample and obtaining a spectrum of the sample.

8. A method as claimed in claim 1 further comprising the step of depositing the sample on a substrate and allowing it to dry.

9. A method as claimed in claim 1 in which a sample excitation is varied in at least one of the time domain and the frequency domain to obtain the spectrum.

10. A method as claimed in claim 1 in which the controllable parameter comprises at least one of the frequency, phase or amplitude of an external excitation source beam.

11. A method as claimed in claim 1 further comprising the step of exciting a spectral portion surrounding the vibrational mode using an excitation beam, generating a broadband local oscillator field in the sample by a broadband excitation source, and detecting a spatially resolvable output beam.

12. A spectroscopy apparatus comprising an excitation source arranged so as to excite a vibrational mode of a sample, generate a homodyne reflected signal from the sample and obtain a spectrum of the sample from the homodyne reflected signal.

13. A spectroscopy apparatus comprising an excitation source arranged so as to excite a vibrational mode of a sample and generate an output signal and comprising a further excitation source arranged so as to excite an electronic mode of the sample and enhance the output signal, obtaining a spectrum of the sample.

14. A spectroscopy apparatus comprising a sample deposited on a substrate and an excitation source arranged so as to excite a vibrational or electronic mode of the sample and obtain a spectrum of the sample.

15. A spectroscopy apparatus as claimed in claim 12 further arranged to carry out the method steps of any of claims 1 to 11.

16. A method or apparatus as claimed in claim 1 wherein exciting a vibrational mode of a sample encompasses inducing a vibrational coherence within the sample.

17. A method of multi dimensional spectroscopy having a controllable excitation source parameter, comprising controlling said controllable parameter to excite a vibrational mode of the sample, generating a reflected signal from the sample and obtaining a spectrum of the sample from the reflected signal.

18. A spectroscopy apparatus comprising an excitation source arranged so as to excite a vibrational mode of a sample, generate a reflected signal from the sample and obtain a spectrum of the sample from the reflected signal.
